(19) United States
(12) Patent Application Publication
(10) Pub. No.: US 2018/0310065 A1
(43) Pub. Date: Oct. 25, 2018

(54) Intelligent Playing System and Intelligent Playing Method

(71) Applicant: BOE Technology Group Co., Ltd., Beijing (CN)

(72) Inventor: Tadashi Nakai, Beijing (CN)

(73) Assignee: BOE Technology Group Co., Ltd., Beijing (CN)

(21) Appl. No.: 15/568,754

(22) PCT Filed: Jun. 2, 2017
(86) PCT No.: PCT/CN2017/086951

§ 371 Date: Oct. 23, 2017

(30) Foreign Application Priority Data
Oct. 18, 2016 (CN) 201610908491.9

(51) Int. Cl. H04N 21/454; G06K 9/00; H04N 21/45

(52) U.S. Cl. CPC H04N 21/454; G06K 2009/00322; H04N 21/4532; G06K 9/00288

(57) ABSTRACT

Disclosed are an intelligent playing system and an intelligent playing method. The intelligent playing system includes a signal processing unit, a playing device, a face information acquisition unit and an intelligent playing unit. Wherein the intelligent playing unit includes a face recognizing and processing circuit, which is communicatively connected with a face information acquisition unit and configured to process the current face information and acquire authority information of the current user, and the intelligent playing unit is configured to control the signal processing unit to output the playing signals to the playing device or not according to the authority information. The intelligent playing system automatically restrict viewing and listening by incorporating a face recognition system.

### FIELD OF THE INVENTION

Embodiments of the present invention relate to an intelligent playing system and an intelligent playing method.

### BACKGROUND

At present, many audio-visual contents have age limits with the diversification of audio-visual contents such as TV programs and network videos. In general, it is possible to limit users or audience not conforming to age limits to view these audio-visual contents by setting passwords and entering passwords.

### SUMMARY

The present invention provides an intelligent playing system and an intelligent playing method that automatically and intelligently determine whether different current users have access to audio-visual contents (viewing and/or listening), thereby limiting current users who do not conforming to conditions.

According to at least one embodiment of this disclosure, an intelligent playing system is provided, comprising: a signal processing unit configured to acquire playing signals from input digital signals and output the playing signals; a playing device communicatively connected with the signal processing unit and configured to play according to the playing signals; a face information acquisition unit configured to acquire current face information of a current user; and an intelligent playing unit communicatively connected with the signal processing unit and the face information acquisition unit respectively, wherein the intelligent playing unit comprises a face recognizing and processing circuit communicatively connected with the face information acquisition unit and configured to process the current face information and acquire authority information of the current user, and the intelligent playing unit is configured to control the signal processing unit to output the playing signals to the playing device or not according to the authority information.

For example, in the intelligent playing system provided in embodiments of this disclosure, further comprising: a face information database configured to store registered face information, wherein the face recognizing and processing circuit is communicatively connected with the face information database and is configured to match the current face information acquired by the face information acquisition unit with the registered face information to acquire the authority information.

For example, in the intelligent playing system provided in embodiments of this disclosure, the face recognizing and processing circuit is further configured to store the current face information acquired by the face information acquisition unit in the face information database and register it as the registered face information.

For example, in the intelligent playing system provided in embodiments of this disclosure, the face information database comprises a memory for storing the registered face information.

For example, in the intelligent playing system provided in embodiments of this disclosure, the intelligent playing unit further comprises: a calculation unit communicatively connected with the signal processing unit and the face recognizing and processing circuit respectively, wherein the calculation unit is configured to acquire restriction class information from the input digital signals, acquire the authority information from the face recognizing and processing circuit and process the restriction class information and the authority information to control the signal processing unit to output the playing signals to the playing device or not.

For example, in the intelligent playing system provided in embodiments of this disclosure, the restriction class information comprises a restriction class related with age, and the authority information comprises the age.

For example, in the intelligent playing system provided in embodiments of this disclosure, further comprising: a controller communicatively connected with the calculation unit and configured to input control signals, wherein the control signal triggers the calculation unit to acquire restriction class information from the input digital signals, acquire the authority information from the face recognizing and processing circuit and process the restriction class information and the authority information to control the signal processing unit to output the playing signals to the playing device or not.

For example, in the intelligent playing system provided in embodiments of this disclosure, the face recognizing and processing circuit comprises a first processor and the calculation unit comprises a second processor.

For example, in the intelligent playing system provided in embodiments of this disclosure, the playing signals comprise video signals and audio signals, the signal processing unit comprises a digital signal receiving section configured to receive the input digital signals and output the input digital signals; a display signal processing circuit communicatively connected with the digital signal receiving section and configured to acquire the display signals from the input digital signals and output the display signals; and an audio signal processing circuit communicatively connected with the digital signal receiving section and configured to acquire audio signals from the input digital signals and output the audio signals, the playing device comprises a display panel displaying pictures according to the video signals and an audio player playing sounds according to the audio signals.

For example, in the intelligent playing system provided in embodiments of this disclosure, the intelligent playing unit is communicatively connected with the digital signal receiving section and is configured to control the digital signal receiving section to receive or output the input digital signals or not, or is communicatively connected with the display signal processing circuit and the audio signal processing circuit respectively and is configured to control the display signal processing circuit to acquire or output the display signals or not and control the audio signal processing circuit to acquire or output the audio signals or not.

For example, in the intelligent playing system provided in embodiments of this disclosure, the face recognizing and processing circuit is communicatively connected with the display signal processing circuit that is further configured to convert the current face information and/or the registered face information into display signals.

According to at least one embodiments of this disclosure, an intelligent playing method is provided, comprising: acquiring playing signals from input digital signals and outputting the playing signals; acquiring current face information of a current user; processing the current face information and acquiring authority information of the current user; and determining whether or not to output the playing signals to the playing device and play according to the authority information.

For example, in the intelligent playing method provided in embodiments of this disclosure, further comprising: registering and storing registered face information; and matching the current face information and the registered face information to acquire the authority information.

For example, in the intelligent playing method provided in embodiments of this disclosure, the registering and storing registered face information comprises:

acquiring face information of a registered user; inputting authority information of the registered user; and associating the face information of the registered user and the authority information of the registered user and storing as the registered face information.

For example, in the intelligent playing method provided in embodiments of this disclosure, further comprising: acquiring restriction class information of input video information; and matching the restriction class information and the authority information to determine whether or not to output the playing signals to the playing device.

### BRIEF DESCRIPTION OF DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 is a schematic diagram of an intelligent playing system provided in an embodiment of the present invention;

FIG. 2 is a schematic diagram of another intelligent playing system provided in an embodiment of the present invention;

FIG. 3 is a schematic diagram of another intelligent playing system provided in an embodiment of the present invention;

FIG. 4 is a schematic diagram of an intelligent playing unit provided in an embodiment of the present invention;

FIG. 5 is a schematic diagram of another intelligent playing system provided in an embodiment of the present invention;

FIG. 6 is a schematic diagram of another intelligent playing system provided in an embodiment of the present invention;

FIG. 7 is a schematic diagram of a screen menu of an intelligent playing system provided in an embodiment of the present invention;

FIG. 8 is a logical flowchart of registering face information provided in an embodiment of the present invention;

FIG. 9 is a logical flowchart of intelligent playing provided in an embodiment of the present invention; and

FIG. 10 is a flowchart of an intelligent playing method provided in an embodiment of the present invention.

### DETAIL DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present application for disclosure, are not intended to indicate any sequence, amount or importance, but distinguish various components. Also, the terms such as “a,” “an,” etc., are not intended to limit the amount, but indicate the existence of at least one. The terms “comprise,” “comprising,” “include,” “including,” etc., are intended to specify that the elements or the objects stated before these terms encompass the elements or the objects and equivalents thereof listed after these terms, but do not preclude the other elements or objects.

The inventor of the present application has noticed in study that common TVs or computers have no audio-visual (video plus audio) restriction function for immature persons or children; and if an immature person or child views audio-visual contents that do not conform to his or her age, it would cause unhealthy influence on his or her growth. In general, it is possible to set numerical passwords for individual audio-visual contents or TV channels and access the audio-visual contents or TV channels by entering the numerical passwords for unlocking. However, this approach requires complicated operations and remembering passwords, which would result in inconvenience for users.

Embodiments of the present invention provide an intelligent playing system and an intelligent playing method. An intelligent playing system comprising: a signal processing unit configured to acquire playing signals from input digital signals and output said playing signals; a playing device communicatively connected with said signal processing unit and configured to play according to said playing signals; a face information acquisition unit configured to acquire current face information of a current user; and an intelligent playing unit communicatively connected with said signal processing unit and said face information acquisition unit respectively, wherein said intelligent playing unit comprises a face recognizing and processing circuit communicatively connected with said face information acquisition unit and configured to process said current face information and acquire authority information of the current user, and said intelligent playing unit is configured to control said signal processing unit to output said playing signals to said playing device or not according to said authority information. The intelligent playing system may determine whether a user has access to the current audio-visual content (viewing and/or listening) by automatically recognizing the current user, thereby restricting current users who do not conform to conditions.

The intelligent playing system and the intelligent playing method provided in embodiments of the present invention will be explained below with respect to accompanying drawings.

### Embodiment I

The present embodiment provides an intelligent playing system. As shown in FIG. 1, the intelligent playing system includes a signal processing unit 110, a playing device 120, a face information acquisition unit 130 and an intelligent playing unit 140. The signal processing unit 110 is configured to acquire and output playing signals from the input digital signals. For example, the signal processing unit 110 may acquire playing signals for TV programs form cable TV signals or acquire playing signals for network audio-visual contents from network signals. The playing device 120 is communicatively connected with the signal processing unit 110 and is configured to play according to playing signals. The face information acquisition unit 130 is configured to acquire current face information of the current user, and may be for example a pick-up head or a camera. The intelligent playing unit 140 is communicatively connected with the signal processing unit 110 and the face information acquisition unit 130 respectively. The intelligent playing unit 140 includes a face recognizing and processing circuit 141 that is communicatively connected with the face information acquisition unit 130 and configured to process the current face information and acquire the authority information of the current user. And according to the authority information, the intelligent playing unit 140 controls the signal processing unit to output playing signals to the playing device 120 or not. It is to be noted the current user refers to a person who is using the intelligent playing system, while a user refers to a person who possesses, uses or manages the intelligent system. In addition, the above-mentioned “communicatively connected” refers to capability of transferring or receiving data information to or from each other in a wired manner such as connection through cables or optical fibers and a wireless manner such as connection through wireless networks such as wifi. In the intelligent playing system provided in the present embodiment, the intelligent playing system may acquire the authority information of the current user by acquiring the current face information of the current user, for example, acquire the authority information of the current user by analyzing the current face information such as a face picture with the face recognizing and processing circuit to obtain the approximate age of the current user. Then, the intelligent playing system may automatically recognize the current user and determine whether the current user has access to the current audio-visual content (viewing and/or listening) and thereby restrict the current users who do not conform to conditions by controlling, with the intelligent playing unit, the signal processing unit according to the authority information to output playing signals to the playing device or not. Thereby, the intelligent playing system may manage audio-visual contents conveniently and automatically and restrict the current users who do not conform to conditions.

For example, in the intelligent playing system provided in an example of the present embodiment, a memory and a processor as well computer program instructions stored in the memory are further included. While the computer program instructions are executed by the processor, the following steps may be carried out: acquiring playing signals from the input digital signals; outing the playing signals; acquiring current face information of the current user; processing the current face information and acquiring the authority information of the current user; and determining whether or not to output playing signals to the playing device according to the authority information.

For example, the playing signals acquired by the signal processing unit from the input digital signals limit the viewing age to older than 17 years, while the age of the user in the year acquired by the face recognizing and processing circuit via the current face information of the current user is 14 years, which does not satisfy the restriction requirement by the playing signals. Now the intelligent playing unit controls the signal processing unit not to output playing signals to the playing device, thereby restricting the current user to access the playing signals. It is to be noted that embodiments of the present invention include, but not limited to the above-mentioned specific implementation. For example, the intelligent playing system may also be configured to manage confidential audio-visual information to guarantee safety of the confidential audio-visual information and the convenience of accessing non-confidential audio-visual information by setting different rights. For example, in a company or a business, it is possible to set corresponding right information according to different positions to manage audio-visual contents that need to be kept secret. As another example, the audio-visual content provider may also restrict corresponding right information according to the users' different VIP levels to manage audio-visual contents that need payment.

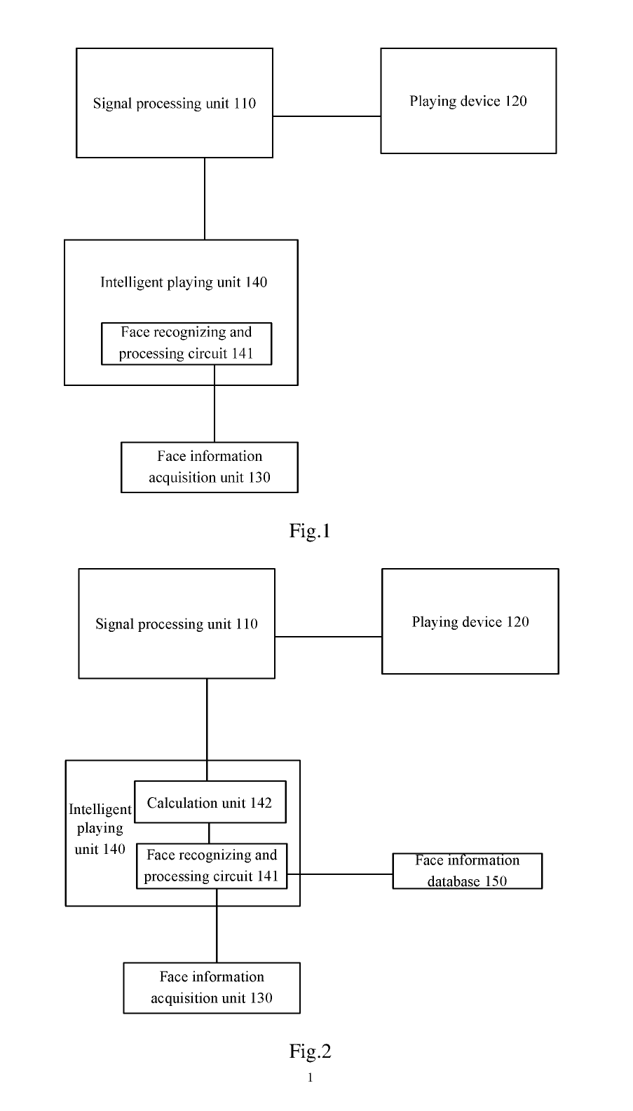

For example, in the intelligent playing system provided in an example of the present embodiment, as shown in FIG. 2, the intelligent playing system may further include a face information database 150. The face information database 150 is configured to store registered face information and the face recognizing and processing circuit 141 may be communicatively connected with the face information database 150 and may be configured to match the current face information acquired by the face information acquisition unit 130 with the registered face information to acquire the authority information.

For example, it is possible to store the face information and their authority information (such as ages) of the objects to be restricted such as immature persons or children in the user's family or objects not to be restricted such as adults in the user's family in the face information database in association and register them as registered face information, and the face recognizing and processing circuit may match the acquired current face information with the registered face information in the face information database to acquire the authority information of the current user. It is to be noted that the above-mentioned authority information may include a plurality of levels and correspond to different authority requirements. For example, audio-visual contents may be divided into a plurality of classes of restriction which require different youngest viewing ages respectively such as 10, 14 and 17 years. Now the authority information may also include corresponding classes such as class A of younger than 10 years who can not view all the audio-visual contents, class B of younger than 14 years and older than 10 years who can view audio-visual contents with the youngest viewing age of 10 years, class C of younger than 17 years and older than 14 years who can view audio-visual contents with the youngest viewing age of 10 and 14 years, and class D of older than 17 years who can view all the audio-visual contents.

For example, in the intelligent playing system provided in an example of the present embodiment, the face recognizing and processing circuit may be further configured to store the current face information acquired by the face information acquisition unit in the face information database and register it as the registered face information. Therefore, it is possible to register the acquired current face information and store it in the face information database with the face recognizing and processing circuit and the face information acquisition unit.

For example, the face information database may include a memory to store registered face information which may be a RAM, a ROM, etc.

For example, in the intelligent playing system provided in an example of the present embodiment, as shown in FIG. 2, the intelligent playing system may further include a calculation unit 142. The calculation unit 142 is communicatively connected with the signal processing unit 110 and the face recognizing and processing circuit 141 respectively. The calculation unit 142 may acquire the restriction class information of playing signals (audio-visual contents) in the input digital signals from the input digital signals, and may further acquire the authority information of the current user from the face recognizing and processing circuit 141 to thereby process the above-mentioned restriction class information and the authority information, and in turn control the processing unit 110 to output playing signals to the playing device 120 or not. It is to be noted that the above-mentioned face recognizing and processing circuit may acquire the authority information of the current user by processing the current face information separately, for example, analyzing the current face information for the age of the current user, or acquiring the authority information by matching the current face information with the registered face information stored in the face information database, which is not limited in embodiments of the present invention.

For example, the above-mentioned restriction class information may include restriction classes related to age and the above-mentioned authority information may include age. Of course, the above-mentioned restriction class information may also be restriction class related to other conditions such as restriction class related to position or VIP grade. Also, the above-mentioned authority information may also be restriction class related to other conditions, such as position or VIP grade, which is not limited in embodiments of the present invention.

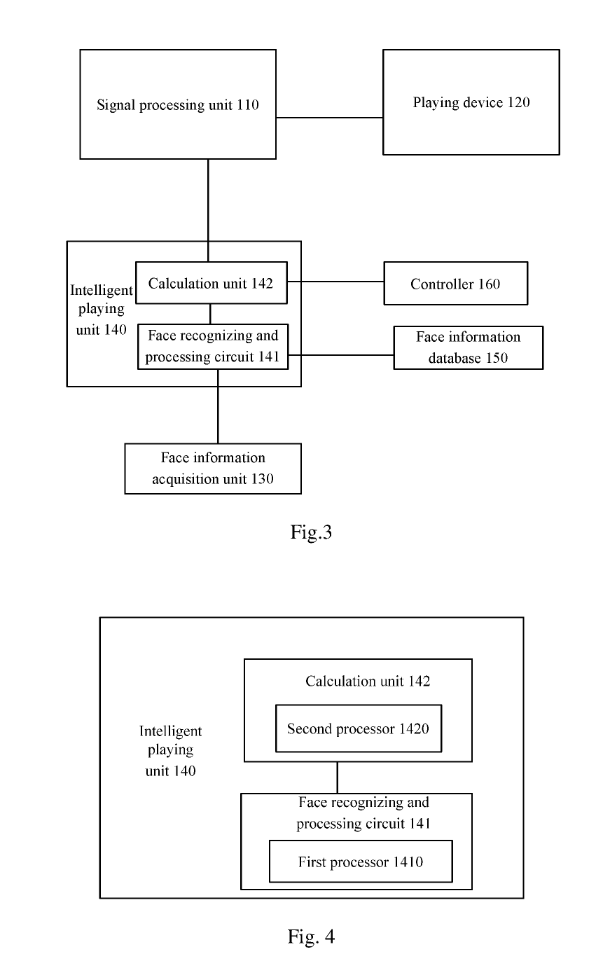

For example, in the intelligent playing system provided in an example of the present embodiment, as shown in FIG. 3, the intelligent playing system may further include a controller 160. The controller 160 is communicatively connected with the calculation unit 142 and configured to input control signals. For example, the control signals may trigger the calculation unit 142 to acquire restriction class information from the input digital signals, acquire the authority information from the face recognizing and processing circuit 141 and process the restriction class information and the authority information to control the signal processing unit 110 to output playing signals to the playing device 120 or not. For example, when the intelligent playing system provided in the present embodiment is applied to a TV set, the controller 160 may be the remote controller with which the current user may input control signals to select TV programs he or she want to view or listen. Now the control signal triggers the calculation unit to acquire the restriction class information from the input digital signals, acquire the authority information from the face recognizing and processing circuit and process the restriction class information and the authority information to control the signal processing unit to output playing signals to the playing device or not at the same time. Therefore, the intelligent playing system provided in the present embodiment may allow the current user to use more conveniently.

For example, FIG. 4 is a schematic diagram of an intelligent playing unit. As shown in FIG. 4, in the intelligent playing unit 140, the face recognizing and processing circuit 141 includes a first processor 1410 configured to perform various operations and processing related to the face recognizing and processing circuit 141; and the calculation unit 142 includes a second processor 1420 configured to perform various operations and processing related to the calculation unit 142. For example, the first processor 1410 may include a CPU, and the second processor 1420 may include a CPU.

For example, in the intelligent playing system provided in an example of the present embodiment, the first and second processor may be integrated. That is, the first processor and the second processor may be the same processor.

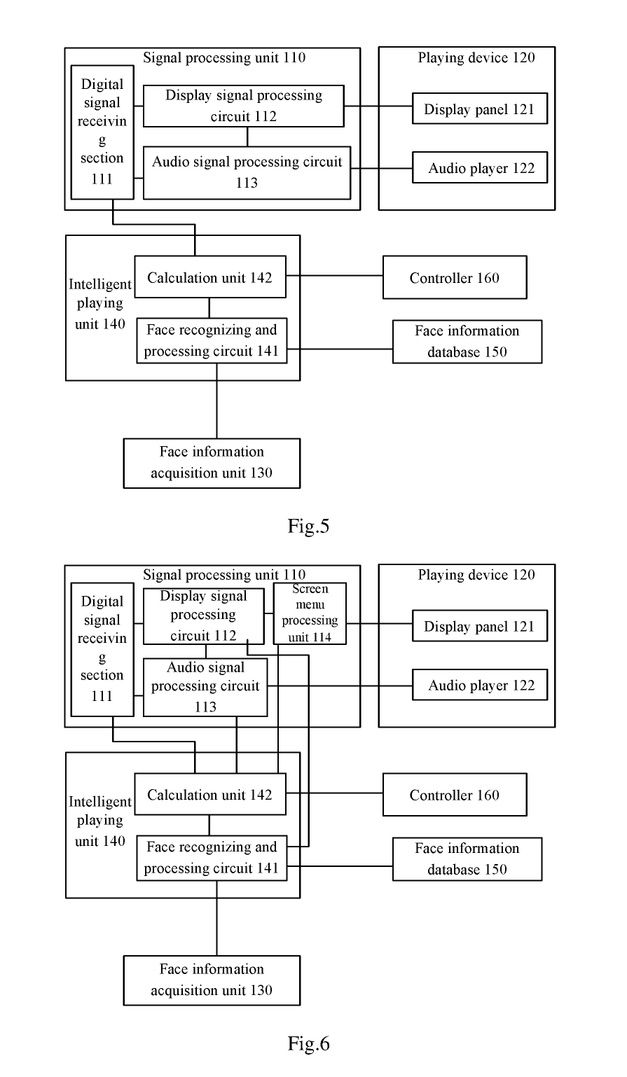

For example, in the intelligent playing system provided in an example of the present embodiment, the playing signals may include video signals and audio signals. As shown in FIG. 5, the playing device 120 includes a display panel 121 displaying pictures according to video signals and an audio player 122 playing sounds according to audio signals. Therefore, the playing device 120 may play video and audio. Of course, the playing device may include only a display panel or an audio player, which is not limited in embodiments of the present invention.

For example, in the intelligent playing system provided in an example of the present embodiment, as shown in FIG. 5, the signal processing unit 110 may include a digital signal receiving section 111, a display signal processing circuit 112 and an audio signal processing circuit 113. The digital signal receiving section 111 is configured to receive and output input digital signals, for example, receiving cable TV signals or network signals. The display signal processing circuit 112 is communicatively connected with the digital signal receiving section 111 to acquire and output display signals from the input digital signals. The audio signal processing circuit 113 is communicatively connected with the digital signal receiving section 111 and configured to acquire and output audio signals from the input digital signals.

For example, in the intelligent playing system provided in an example of the present embodiment, as shown in FIG. 5, the intelligent playing unit 140 (for example, the calculation unit 142 in the intelligent playing unit 140) may allow or restrict the current to access the audio-visual contents in the input digital signals by communicatively connecting with the digital signal receiving section 111 to control the digital signal receiving section 111 to receive or output the input digital signals or not.

For example, in the intelligent playing system provided in an example of the present embodiment, as shown in FIG. 6, the intelligent playing unit 140 (for example, the calculation unit 142 in the intelligent playing unit 140) may control the display signal processing circuit 112 to acquire or output display signals or not by communicatively connecting with the display signal processing circuit 112 and the audio signal processing circuit 113, thereby allowing or restricting the current user to view the video of the display signals, control the audio signal processing circuit 113 to acquire or output audio signals, thereby allowing or restricting the current user to receive audio of the audio signals.

For example, in the intelligent playing system provided in an example of the present embodiment, as shown in FIG. 6, the intelligent playing unit 140 may acquire the restriction class information in the input digital signals by communicatively connecting the calculation unit 142 with the digital signal receiving section 111.

For example, in the intelligent playing system provided in an example of the present embodiment, as shown in FIG. 6, the face recognizing and processing circuit 141 may be communicatively connected with the display signal processing circuit 112 that may convert the current face information and/or the registered face information into display signals. Thereby, the intelligent playing system provided in the present embodiment facilitates the user's registration.

For example, in the intelligent playing system provided in an example of the present embodiment, as shown in FIG. 6, the signal processing unit 110 may further include a screen menu processing unit 114 communicatively connected with the display signal processing circuit 112 and the display panel 121, which can add display signals of the screen menu on the display signals output from the display signal processing circuit 112 and output the result to the display panel 121.

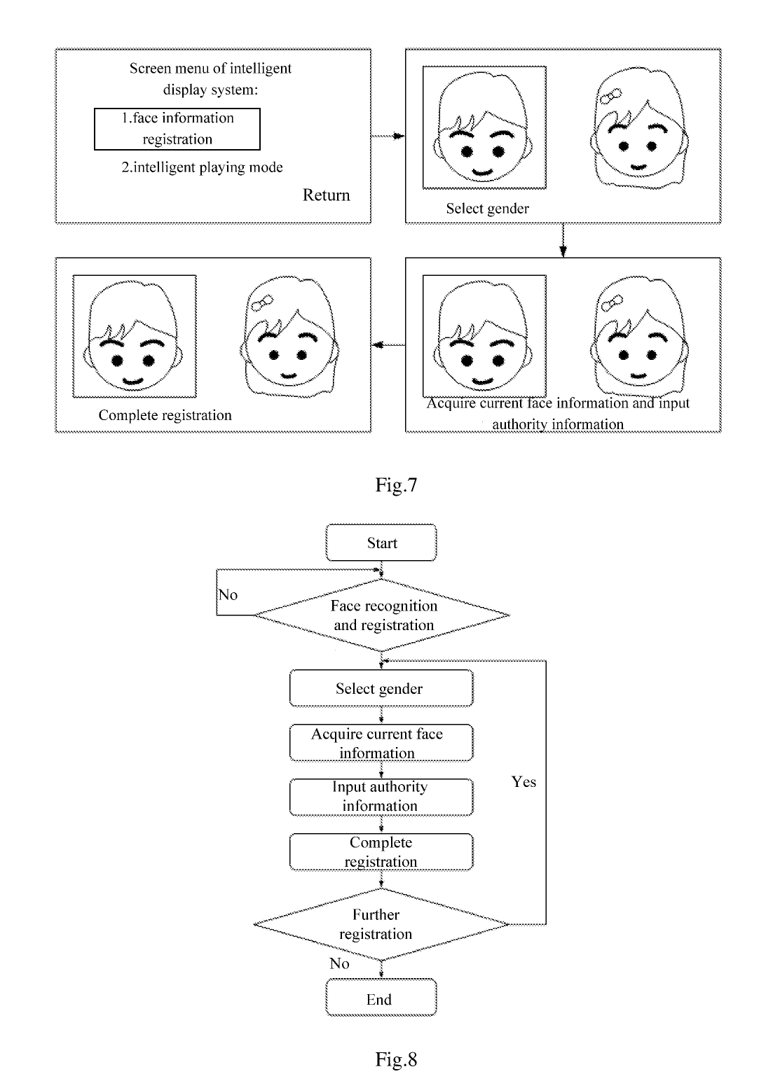

For example, in the intelligent playing system provided in an example of the present embodiment, FIG. 7 is a schematic diagram of a screen menu. As shown in FIG. 7, the screen menu of the intelligent playing system may include a face information registration mode and an intelligent playing mode. Selecting the face information registration mode may enter the face information registration interface to register the face information. Selecting the intelligent playing mode may enter the intelligent playing mode to play intelligently.

For example, FIG. 8 is a logical flowchart of registering face information. As shown in FIGS. 7 and 8, the first step is selecting the face information registration to decide whether or not to register face information; the second step is selecting the gender of the user to be registered; the third step is acquiring the current face information (face image) of the current user with the face information acquisition unit such as a pick-up head; the fourth step is inputting the authority information corresponding to the acquired current face information; the fifth step is registering the current face information and the corresponding authority information in association as the registered face information to complete registration; and the sixth step is selecting whether or not to perform additional registration.

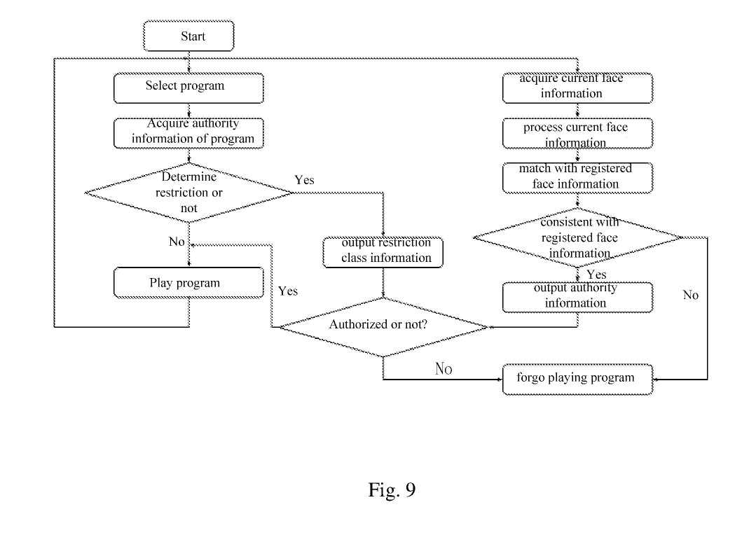

For example, FIG. 9 is a logical flowchart of intelligent playing. As shown in FIG. 9, the intelligent playing system is entered and the current face information is acquired at the same time. The program to be played is selected, for example by a controller. It is possible to determine by the intelligent playing unit whether the program need to be restricted, and if not, the intelligent playing unit controls the signal processing unit to output playing signals to the playing device to play program, and if so, restriction is needed and the restriction class information of the program is output. On the other hand, the face recognizing and processing circuit may process the acquired current face information; match it with the registered face information; output the authority information if consistent with the registered face information; and determine by the intelligent playing unit according to the restriction class information and the authority information whether the current user has access to the program, and play the program if so, and do not play the program if not, and if inconsistent with the registered face information, control, by the intelligent playing unit, the signal processing unit not to output the playing signals to restrict the playing of the program. Of course, the above-mentioned specific implementations are merely for the purpose of describing the intelligent playing system provided in the present embodiment and embodiments of the present invention include, but not limited to these.

### Embodiment II

The present embodiment provides an intelligent playing equipment including the intelligent playing system described in any one of the above-mentioned embodiments. Since the intelligent playing equipment includes the intelligent playing system described in any one of the above-mentioned embodiments, the intelligent playing equipment has the technique effect corresponding to that of the intelligent playing system included therein which may be found with reference to the relevant description in the embodiment I and will not be described any more herein in embodiments of the present invention. In addition, for the intelligent playing equipment provided in the present embodiment, conventional components or devices may be used as components or devices other than the intelligent playing system.

For example, the intelligent playing equipment may be any product or component with intelligent playing function such as a TV set, a cell phone, a tablet, a notebook computer etc.

### Embodiment III

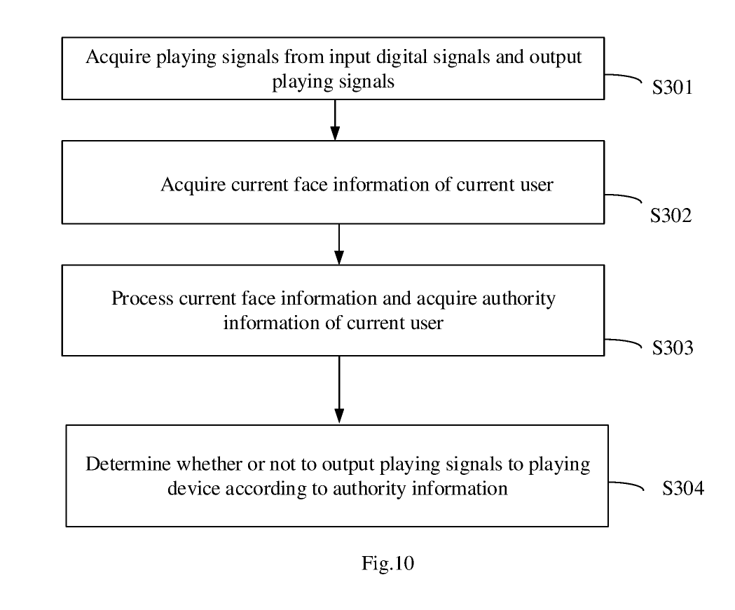

The present embodiment provides an intelligent playing method. FIG. 10 is a flowchart of an intelligent playing method. As shown in FIG. 10, the intelligent playing method includes steps S301-S304.

S301: acquiring playing signals from the input digital signals and outputting the playing signals.

For example, the input digital signals may be cable TV signals or network signals.

S302: acquiring the current face information of the current user.

For example, it is possible to acquire the current face information of the current user by a camera or a pick-up head. Of course, it is also possible to use other devices to acquire the current face information of the current user which is not limited herein in embodiments of the present invention.

S303: processing the current face information and acquiring the authority information of the current user.

For example, the authority information may include age and the age of the current user is acquired by analyzing the current face information. Of course, it is also possible to use other approaches to acquire the authority information of the current user which is not limited herein in embodiments of the present invention.

S304: determining whether or not to output playing signals to the playing device and play in accordance with the authority information.

In the intelligent playing method provided in the present embodiment, it is possible to acquire the authority information of the current user by acquiring the current face information of the current user; then it is possible to determine whether or not to output playing signals to the playing device in accordance with the authority information to thereby automatically recognize the current user and determine whether the current user has access to the current audio-visual content (viewing and/or listening), thereby restricting the current user who does not satisfy the conditions. Thereby, the intelligent playing system may manage audio-visual contents conveniently and automatically and restrict current users who do not satisfy conditions.

For example, in the intelligent playing method provided in an example of the present embodiment, it further includes registering and storing the face information; and matching the current face information with the registered face information to acquire the authority information. For example, the registered face information may be the information of face information and corresponding authority information stored in association; and thereby it is possible to acquire the authority information of the current user by matching the current face information with the prestored face information and the authority information stored in association.

For example, in the intelligent playing method provided in an example of the present embodiment, registering and storing face information may include: acquiring the face information of the registered user, for example, by acquiring the face information of the registered user with a camera or a pick-up head; and inputting the authority information of the registered user and associating the face information of the registered user and the authority information of the registered user and storing it as registered face information.

For example, in the intelligent playing method provided in an example of the present embodiment, the intelligent playing method further includes: acquiring the restriction class information of the input digital information; and matching the restriction class information with the authority information to determine whether or not to output playing signals to the playing device, thereby determining whether or not to restrict the current user to access the audio-visual contents of the playing signals. For example, the restriction class information includes the restriction class related with age, and the authority information is the age.

For example, in the intelligent playing method provided in an example of the present embodiment, the playing signals include video signals and audio signals, and the playing device includes a display panel that displays pictures according to the video signals and an audio player that plays sounds according to the audio signals.

It should be noted as follows:

(1) The drawings of the embodiments of the present disclosure only relate to the structure in connection with the embodiments of the present disclosure, and conventional design can be referred to for other structures.

(2) For clarity, in the figures for describing the embodiments of the present disclosure, the thicknesses of layers or regions are exaggerated or diminished, i.e., the drawings are not drawn to actual scale. It should be known that, when a component such as layer, film, area or substrate and so on is called “on” or “below” another component, this component may being “on” or “below” another component “directly”, or there could exists intermediate component.

(3) Without conflict, embodiments of the present disclosure and features in the embodiments can be combined with each other to obtain new embodiments.

(4) For the circuit units described in embodiments of the present invention, those skilled in the art may build corresponding hardware circuits to implement corresponding functions, said hardware circuits including conventional very large scale integrated (VLSI) circuits or gate arrays and existing semiconductor devices such as logic chips and transistors or other discrete elements.

What are described above is related to the illustrative embodiments of the disclosure only and not limitative to the scope of the disclosure; the scopes of the disclosure are defined by the accompanying claims.

The present application claims the priority of the Chinese Patent Application No. 201610908491.9 filed on Oct. 18, 2016, which is incorporated herein in its entirety by reference as part of the disclosure of the present application.

1. An intelligent playing system, comprising:
a signal processing unit configured to acquire playing signals from input digital signals and output the playing signals;
a playing device communicatively connected with the signal processing unit and configured to play according to the playing signals;
a face information acquisition unit configured to acquire current face information of a current user; and
an intelligent playing unit communicatively connected with the signal processing unit and the face information acquisition unit respectively,
wherein the intelligent playing unit comprises a face recognizing and processing circuit, the face recognizing and processing circuit communicatively connected with the face information acquisition unit and configured to process the current face information and acquire authority information of the current user, and the intelligent playing unit is configured to control the signal processing unit to output the playing signals to the playing device or not according to the authority information.

2. The intelligent playing system of claim 1, further comprising:
a face information database configured to store registered face information,
wherein the face recognizing and processing circuit is communicatively connected with the face information database and is configured to match the current face information acquired by the face information acquisition unit with the registered face information to acquire the authority information.

3. The intelligent playing system of claim 2, wherein, the face recognizing and processing circuit is further configured to store the current face information acquired by the face information acquisition unit in the face information database and register it as the registered face information.

4. The intelligent playing system of claim 2, wherein, the face information database comprises a memory for storing the registered face information.

5. The intelligent playing system of claim 1, wherein, the intelligent playing unit further comprises:
a calculation unit communicatively connected with the signal processing unit and the face recognizing and processing circuit respectively,
wherein the calculation unit is configured to acquire restriction class information from the input digital signals, acquire the authority information from the face recognizing and processing circuit and process the restriction class information and the authority information to control the signal processing unit to output the playing signals to the playing device or not.

6. The intelligent playing system of claim 5, wherein, the restriction class information comprises a restriction class related with age, and the authority information comprises the age.

7. The intelligent playing system of claim 6, further comprising:
a controller communicatively connected with the calculation unit and configured to input control signals,
wherein the control signal triggers the calculation unit to acquire restriction class information from the input digital signals, acquire the authority information from the face recognizing and processing circuit and process the restriction class information and the authority information to control the signal processing unit to output the playing signals to the playing device or not.

8. The intelligent playing system of claim 5, wherein, the face recognizing and processing circuit comprises a first processor and the calculation unit comprises a second processor.

9. The intelligent playing system of claim 1, wherein, the playing signals comprise video signals and audio signals, the signal processing unit comprises a digital signal receiving section configured to receive the input digital signals and output the input digital signals; a display signal processing circuit communicatively connected with the digital signal receiving section and configured to acquire the display signals from the input digital signals and output the display signals; and an audio signal processing circuit communicatively connected with the digital signal receiving section and configured to acquire audio signals from the input digital signals and output the audio signals, the playing device comprises a display panel displaying pictures according to the video signals and an audio player playing sounds according to the audio signals.

10. The intelligent playing system of claim 9, wherein, the intelligent playing unit is communicatively connected with the digital signal receiving section and is configured to control the digital signal receiving section to receive or output the input digital signals or not, or is communicatively connected with the display signal processing circuit and the audio signal processing circuit respectively and is configured to control the display signal processing circuit to acquire or output the display signals or not and control the audio signal processing circuit to acquire or output the audio signals or not.

11. The intelligent playing system of claim 9, wherein, the face recognizing and processing circuit is communicatively connected with the display signal processing circuit that is further configured to convert the current face information and/or the registered face information into display signals.

12. An intelligent playing method comprising:
acquiring playing signals from input digital signals and outputting the playing signals;
acquiring current face information of a current user;
processing the current face information and acquiring authority information of the current user; and
determining whether or not to output the playing signals to the playing device and play according to the authority information.

13. The intelligent playing method of claim 12, further comprising:
registering and storing registered face information; and
matching the current face information and the registered face information to acquire the authority information.

14. The intelligent playing method of claim 13, wherein, the registering and storing registered face information comprises:
acquiring face information of a registered user;
inputting authority information of the registered user; and
associating the face information of the registered user and the authority information of the registered user and storing as the registered face information.

15. The intelligent playing method of claim 12, further comprising:
acquiring restriction class information of input video information; and
matching the restriction class information and the authority information to determine whether or not to output the playing signals to the playing device.

16. The intelligent playing method of claim 15, wherein, the restriction class information comprises a restriction class related with age, and the authority information comprises the age.

17. The intelligent playing method of claim 16, further comprising:
input control signals;
wherein the control signal triggers to acquire restriction class information from the input digital signals, to acquire the authority information, and process the restriction class information and the authority information to control outputting the playing signals to the playing device or not.

18. The intelligent playing method of claim 13, wherein, the playing signals comprise video signals and audio signals, comprising:
receive the input digital signals and output the input digital signals;
acquire the display signals from the input digital signals and output the display signals;
acquire audio signals from the input digital signals and output the audio signals,
the playing device comprises a display panel displaying pictures according to the video signals and an audio player playing sounds according to the audio signals.

19. The intelligent playing method of claim 18, comprising:
convert the current face information and/or the registered face information into the display signals.
